(19) United States
(12) Patent Application Publication
(10) Pub. No.: US 2024/0161250 A1
(43) Pub. Date: May 16, 2024

(54) TECHNIQUES FOR DENOISING DIFFUSION USING AN ENSEMBLE OF EXPERT DENOISERS

(71) Applicant: NVIDIA CORPORATION, Santa Clara, CA (US)

(72) Inventors: Yogesh BALAJI, Mountain View, CA (US); Timo Oskari AILA, Tuusula (FI); Miika AITTALA, Tuusula (FI); Bryan CATANZARO, Los Altos Hills, CA (US); Xun HUANG, Mountain View, CA (US); Tero Tapani KARRAS, Helsinki (FI); Karsten KREIS, Vancouver (CA); Samuli LAINE, Vantaa (FI); Ming-Yu LIU, San Jose, CA (US); Seungjun NAH, Santa Clara, CA (US); Jiaming SONG, San Carlos, CA (US); Arash VAHDAT, San Mateo, CA (US); Qinsheng ZHANG, Santa Clara, CA (US)

(21) Appl. No.: 18/485,239

(22) Filed: Oct. 11, 2023

Related U.S. Application Data
(60) Provisional application No. 63/382,280, filed on Nov. 3, 2022.

(51) Int. Cl. G06T 5/00

(52) U.S. Cl. CPC G06T 5/002; G06T 2207/20081; G06T 2207/20084

(57) ABSTRACT

Techniques are disclosed herein for generating a content item. The techniques include performing one or more first denoising operations based on an input and a first machine learning model to generate a first content item, and performing one or more second denoising operations based on the input, the first content item, and a second machine learning model to generate a second content item, where the first machine learning model is trained to denoise content items having an amount of corruption within a first corruption range, the second machine learning model is trained to denoise content items having an amount of corruption within a second corruption range, and the second corruption range is lower than the first corruption range.

### CROSS-REFERENCE TO RELATED APPLICATIONS

This application claims priority benefit of the U.S. Provisional Patent Application titled, “TEXT-TO-IMAGE DIFFUSION MODELS WITH AN ENSEMBLE OF EXPERT DENOISERS,” filed on Nov. 3, 2022, and having Ser. No. 63/382,280. The subject matter of this related application is hereby incorporated herein by reference.

### BACKGROUND

### Technical Field

Embodiments of the present disclosure relate generally to artificial intelligence/machine learning and computer graphics and, more specifically, to techniques for denoising diffusing using an ensemble of expert denoisers.

### Description of the Related Art

Generative models are computer models that can generate representations or abstractions of previously observed phenomena. Denoising diffusion models are one type of generative model that can generate images corresponding to textual input. Conventional denoising diffusion models can be used to generate images via an iterative process that includes removing noise from a noisy image using a trained artificial neural network, adding back a smaller amount of noise than was present in the noisy image, and repeating these steps until a clean image that does not include much or any appreciable noise is generated.

One drawback of conventional image denoising diffusion models is that these models use the same artificial neural network to remove noise throughout the iterative process for generating an image. However, early iterations of that iterative process focus on generating image content that aligns with the textual input, whereas later iterations of the iterative process focus on generating image content that has high visual quality. As a result of using the same artificial neural network throughout the iterative image generation process, conventional image denoising diffusion models sometimes generate images that do not accurately represent the textual input used to generate those images. For example, objects described in the textual input may not appear in an image generated by a conventional image denoising diffusion model based on that textual input. As another example, words from the textual input may be misspelled in an image generated by a conventional image denoising diffusion model based on that textual input.

As the foregoing illustrates, what is needed in the art are more effective techniques for generating images using denoising diffusion models.

### SUMMARY

One embodiment of the present disclosure sets forth a computer-implemented method for generating a content item. The method includes performing one or more first denoising operations based on an input and a first machine learning model to generate a first content item. The method further includes performing one or more second denoising operations based on the input, the first content item, and a second machine learning model to generate a second content item. The first machine learning model is trained to denoise content items having an amount of corruption within a first corruption range, the second machine learning model is trained to denoise content items having an amount of corruption within a second corruption range, and the second corruption range is lower than the first corruption range.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, content items that more accurately represent textual input can be generated relative to what typically can be generated using conventional denoising diffusion models. Further, with the disclosed techniques, an ensemble of expert denoisers can be trained in a computationally efficient manner relative to training each expert denoiser separately. In addition, the disclosed techniques permit users to control where objects described in textual input appear in a generated content item. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a more detailed illustration of the computing device of FIG. 1, according to various embodiments;

FIG. 3 is a more detailed illustration of how the image generating application of FIG. 1 generates an image, according to various embodiments;

FIG. 4 is a more detailed illustration of how the image generating application of FIG. 1 generates an image, according to various other embodiments;

FIG. 5 illustrates how a mask can be used to specify the locations of objects in an image generated using an ensemble of expert denoisers, according to various embodiments;

FIG. 6A illustrates exemplar images generated using conventional denoising diffusion models, according to the prior art;

FIG. 6B illustrates exemplar images generated using ensembles of expert denoisers, according to various embodiments;

FIG. 7A illustrates additional exemplar images generated using conventional denoising diffusion models, according to the prior art;

FIG. 7B illustrates additional exemplar images generated using ensembles of expert denoisers, according to various embodiments;

FIG. 8A illustrates an exemplar image generated using denoising diffusion conditioned on one text embedding, according to various embodiments;

FIG. 8B illustrates an exemplar image generated using denoising diffusion conditioned on another text embedding, according to various embodiments;

FIG. 8C illustrates an exemplar image generated using denoising diffusion conditioned on two text embeddings, according to various embodiments;

FIG. 9A illustrates an exemplar image generated using denoising diffusion conditioned on two text embeddings, according to various embodiments;

FIG. 9B illustrates an exemplar reference image, according to various embodiments;

FIG. 9C illustrates an exemplar image generated using denoising diffusion conditioned on two text embeddings and an image embedding, according to various embodiments;

FIG. 10 is a flow diagram of method steps for training an ensemble of expert denoisers to generate images, according to various embodiments;

FIG. 11 is a flow diagram of method steps for generating an image using an ensemble of expert denoisers, according to various embodiments; and

FIG. 12 is a flow diagram of method steps for generating an image using multiple ensembles of denoisers, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating content items using one or more ensembles of expert denoiser models (also referred to herein as “expert denoisers”). Although images are discussed herein as a reference example of content items, in some embodiments, techniques disclosed herein can be applied to generate content items that include any technically feasible data that can be corrupted to various degrees, such as bitmap images, video clips, audio clips, three-dimensional (3D) models, time series data, latent representations, etc. In some embodiments, each expert denoiser in an ensemble of expert denoisers is trained to denoise images having an amount of noise within a different noise range. Although discussed herein primarily with respect to noise (e.g., uncorrelated Gaussian noise) as a reference example of corruption in images, in some embodiments, content items can include any technically feasible corruption, such as noise, blur, filtering, masking, pixelation, dimensionality reduction, compression, quantization, spatial decimation, and/or temporal decimation. Given an input text and (optionally) an input image, the expert denoisers in an ensemble of expert denoisers are sequentially applied to denoise images having an amount of noise within the different noise ranges for which the expert denoisers were trained, beginning from an image with random noise and progressing to a clean image that does not include noise, or that includes less than a threshold amount of noise. The input text and input image can also be encoded into text and image embeddings using multiple different text and image encoders, respectively. In addition, multiple ensembles of expert denoisers can be used to generate an image at a first resolution and then increase the image resolution. In some embodiments, each ensemble of expert denoisers can be trained by first training a denoiser to denoise images having any amount of noise, and then re-training the trained denoiser on particular noise ranges to obtain the expert denoisers.

The techniques disclosed herein for generating content items, such as images, using one or more ensembles of expert denoiser have many real-world applications. For example, those techniques could be used to generate content items for a video game. As another example, those techniques could be used for generating stock photos based on a text prompt, image editing, image inpainting, image outpainting, colorization, com positing, super-resolution, image enhancement/restoration, generating 3D models, and/or production-quality rendering of films.

The above examples are not in any way intended to be limiting. As persons skilled in the art will appreciate, as a general matter, the techniques for generating content items using one or more ensembles of expert denoisers can be implemented in any suitable application.

### System Overview

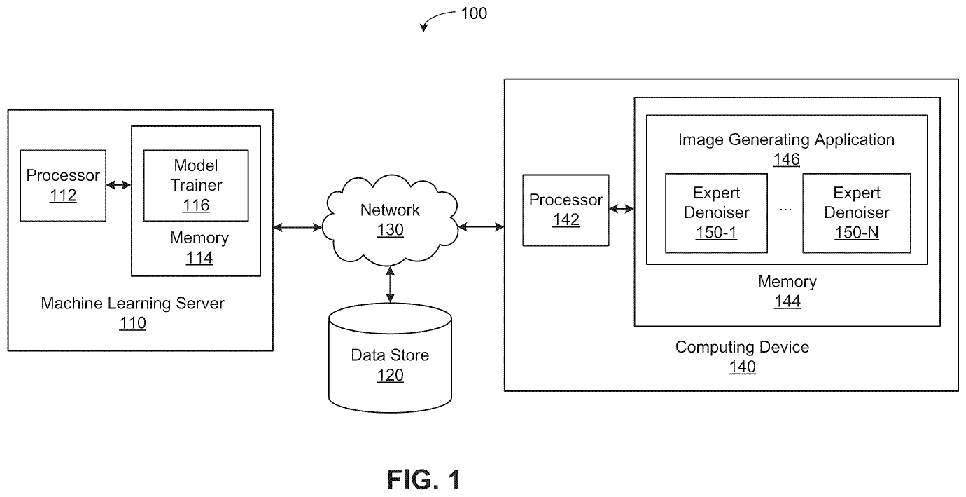

FIG. 1 is a block diagram illustrating a computer system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), or any other suitable network.

As shown, a model trainer 116 executes on a processor 112 of the machine learning server 110 and is stored in a system memory 114 of the machine learning server 110. The processor 112 receives user input from input devices, such as a keyboard or a mouse. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the machine learning server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

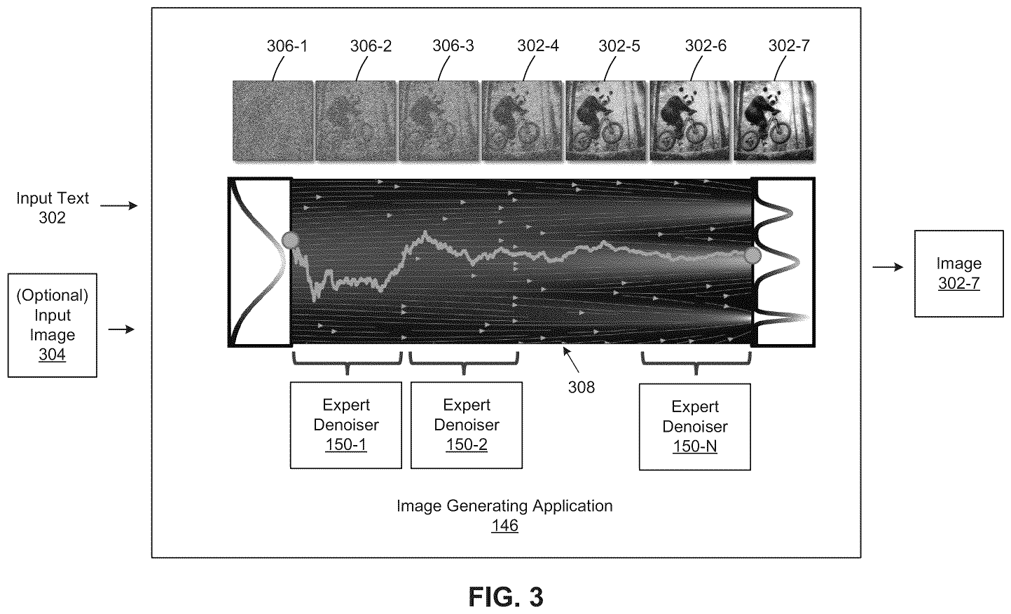

In some embodiments, the model trainer 116 is configured to train one or more machine learning models, including an ensemble of expert denoisers 150-1 to 150-N (referred to herein collectively as expert denoisers 150 and individually as an expert denoiser). The expert denoisers 150 are trained to denoise images having amounts of noise within different noise ranges. Once trained, the expert denoisers 150 can be used sequentially in a denoising diffusion process to generate an image corresponding to text and/or other input. In some embodiments, the denoiser can take application-specific conditioning inputs, such as a text prompt, an image, an embedding, audio, and/or the like. Architectures of the expert denoisers 150 and techniques for training the same are discussed in greater detail below in conjunction with FIGS. 3-5 and 11-12. Training data and/or trained machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

As shown, an image generating application 146 is stored in a memory 144, and executes on a processor 142, of the computing device 140. The image generating application 146 uses the expert denoisers 150 to perform denoising diffusion that generates images from noisy images based on an input, as discussed in greater detail below in conjunction with FIGS. 3-7. In some embodiments, machine learning models, such as the expert denoisers 150, that are trained according to techniques disclosed herein can be deployed to any suitable applications, such as the image generating application 146.

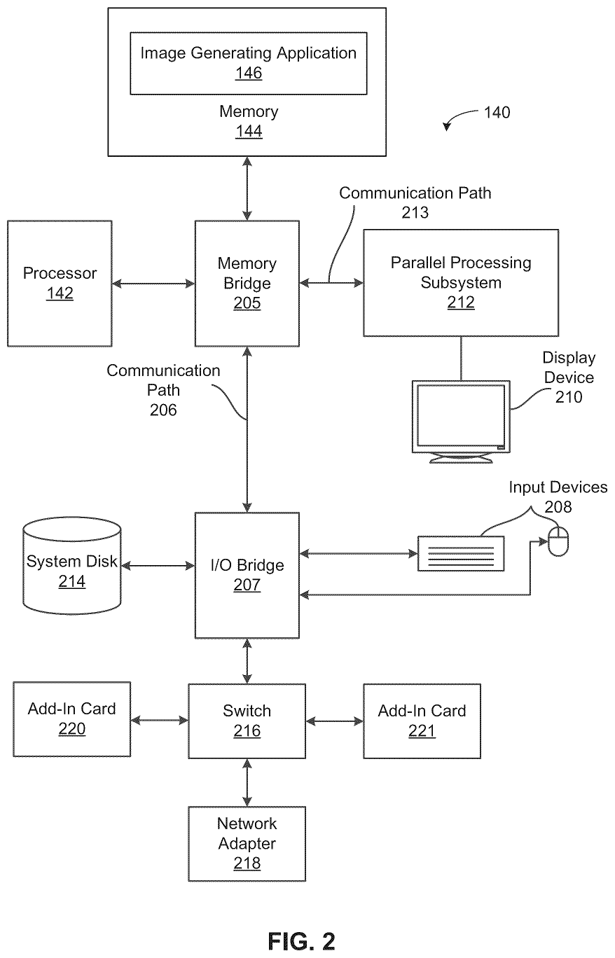

FIG. 2 is a more detailed illustration of the computing device 140 of FIG. 1, according to various embodiments. As persons skilled in the art will appreciate, computing device 140 can be any type of technically feasible computer system, including, without limitation, a server machine, a server platform, a desktop machine, a laptop machine, a hand-held/mobile device, or a wearable device. In some embodiments, computing device 140 is a server machine operating in a data center or a cloud computing environment that provides scalable computing resources as a service over a network. In some embodiments, the machine learning server 110 can include similar components as the computing device 140.

In various embodiments, the computing device 140 includes, without limitation, the processor 142 and the memory 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard or a mouse, and forward the input information to processor 142 for processing via communication path 206 and memory bridge 205. In some embodiments, computing device 140 may be a server machine in a cloud computing environment. In such embodiments, computing device 140 may not have input devices 208. Instead, computing device 140 may receive equivalent input information by receiving commands in the form of messages transmitted over a network and received via the network adapter 218. In one embodiment, switch 216 is configured to provide connections between I/O bridge 207 and other components of the computing device 140, such as a network adapter 218 and various add-in cards 220 and 221.

In one embodiment, I/O bridge 207 is coupled to a system disk 214 that may be configured to store content and applications and data for use by processor 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. System memory 144 includes at least one device driver configured to manage the processing operations of the one or more PPUs within parallel processing subsystem 212. In addition, the system memory 144 includes the image generating application 146, described in greater detail in conjunction with FIGS. 1 and 3-5.

In various embodiments, parallel processing subsystem 212 may be integrated with one or more of the other elements of FIG. 2 to form a single system. For example, parallel processing subsystem 212 may be integrated with processor 142 and other connection circuitry on a single chip to form a system on chip (SoC).

In one embodiment, processor 142 is the master processor of computing device 140, controlling and coordinating operations of other system components. In one embodiment, processor 142 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors (e.g., processor 142), and the number of parallel processing subsystems 212, may be modified as desired. For example, in some embodiments, system memory 144 could be connected to processor 142 directly rather than through memory bridge 205, and other devices would communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 2 may not be present. For example, switch 216 could be eliminated, and network adapter 218 and add-in cards 220, 221 would connect directly to I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Denoising Diffusion Using an Ensemble of Expert Denoisers

FIG. 3 is a more detailed illustration of how the image generating application 146 of FIG. 1 generates an image, according to various embodiments. As shown, the image generating application 146 includes the ensemble of expert denoisers 150. In operation, the image generating application 146 receives an input text 302 and, optionally, an input image 304. Although described herein primarily with respect to text and images as reference examples of inputs, in some embodiments, the image generating application 146 can take any suitable application-specific conditioning inputs, such as a text prompt, an image, an embedding, audio, and/or the like. Given the input text 302 and the optional input image 304 (and/or other conditioning inputs), the image generating application 146 performs denoising diffusion using the expert denoisers 150 to generate and output an image, shown as image 302-7.

Each expert denoiser 150 in the ensemble of expert denoisers 150 is trained to denoise images having an amount of noise within a particular noise range (also referred to herein as a “noise level”). Each of the expert denoisers 150 can have any technically feasible architecture, such as a U-net architecture, an Efficient U-Net architecture, or a modification thereof. To generate an image given the input text 302 and the input image 304, the image generating application 146 sequentially applies the expert denoisers 150 to denoise images having an amount of noise within the particular noise ranges for which the expert denoisers 150 were trained. Illustratively, beginning from an image 306-1 that includes random noise, the image generating application 146 performs iterative denoising diffusion operations in which the image generating application 146 uses the expert denoiser 150-1 to remove noise from the image 306-1 to generate a clean image, the image generating application 146 adds to the clean image a smaller amount of noise than was present in the image 306-1 to generate a noisy image, and the image generating application 146 repeats these steps, until a noisy image is generated that includes an amount of noise that is less than the noise range for which the expert denoiser 150-1 was trained to denoise. Then, the image generating application 146 performs similar iterative denoising diffusion operations using the expert denoiser 150-2 for the noise range that the expert denoiser 150-2 was trained to denoise, etc. As a result, the image 306-1 that includes random noise is progressively denoised to generate a clean image, shown as image 302-7, which does not include noise or includes less than a threshold amount of noise.

More formally, text-to-image diffusion models, such as the expert denoisers 150, generate data by sampling an image from a noise distribution and iteratively denoising the sampled image using a denoising model D(x; e, σ), where x represents the noisy image at the current step, e is an input embedding, and σ is a scalar input indicating the current noise level. In text-to-image diffusion models, the input text can be represented by a text embedding, extracted from a pretrained model such as CLIP or T5 text encoders. The problem of generating images given text then boils down to learning a conditional generative model that takes text embeddings (and optionally other inputs such as images) as input conditioning and generates images aligned with the conditioning.

In some embodiments, each of the expert denoisers 150 is preconditioned using:

$$D ( x ; e , σ ) := {( \frac{{σ}_{data}}{{σ}^{*}} )}^{2} x + \frac{σ \cdot {σ}_{data}}{{σ}^{*}} {F}_{θ} ( \frac{x}{{σ}^{*}} ; e , \frac{ln ( σ )}{4} ) , \qquad ( 1 )$$

where σ*=\sqrt{σ²+σ²_{data}}and F_{θ} is a trained neural network. In some embodiments, σ_{data}=0.5 can be used as an approximation for the standard deviation of pixel values in natural images. For σ, the log-normal distribution ln(σ)˜ [symbol] (Pₘₑₐₙ, P_{std}), with Pₘₑₐₙ=−1.2 and P_{std}=1.2, can be used, along with weighting factor λ(σ)=(σ*/σ·σ_{data}))² that cancels the output weighting of F_{θ} in equation (1). To generate an image with an expert denoiser 150, an initial image is generated by sampling from the prior distribution x˜ [symbol] (0,σₘₐₓ²I), and then the generative ordinary differential equation (ODE) is solved using:

$$\frac{dx}{d σ} = - σ {∇}_{x} log p ( x \vert e , σ ) = \frac{x - D ( x ; e , σ )}{σ} \qquad ( 2 )$$

for σ flowing backward from σₘₐₓ to σₘᵢₙ≈0. In equation (2), ∇ₓlog p(x|e, σ) represents the score function of the corrupted data at noise level σ, which is obtained from the expert denoiser 150 model. In addition, σₘₐₓ represents a high noise level at which the data is substantially completely corrupted, and the mutual information between the input image distribution and the corrupted image distribution is approaching zero. The ODE of equation (2) uses the D(x; e, σ) of equation (1) to guide the samples gradually towards images that are aligned with the input conditioning. It should be noted that sampling can also be expressed as solving a stochastic differential equation.

In some embodiments, the expert denoiser 150, D, at each noise level a can rely on two sources of information for denoising: the current noisy input image x and the input text prompt e. One key observation is that text-to-image diffusion models exhibit a unique temporal dynamic while relying on such sources. At the beginning of denoising diffusion, when a is large, the input image x includes mostly noise. Hence, denoising directly from the input visual content is a challenging and ambiguous task. At this stage, a denoiser D mostly relies on the input text embedding to infer the direction toward text-aligned images. However, as a becomes small towards the end of the denoising diffusion, most coarse-level content is painted by the denoiser. At this stage, the denoiser D mostly ignores the text embedding and uses visual features for adding fine-grained details. As described, in conventional diffusion denoising models, a denoising model is shared across all noise levels. In such cases, the temporal dynamic is represented using a simple time embedding that is fed to the denoising model via a multi-layer perceptron (MLP) network. However, the complex temporal dynamics of the denoising diffusion may not be learned from data effectively using a shared model with limited capacity. By instead using expert denoisers 150, each expert denoiser 150 being specialized for a particular range of noises, the model capacity can be increased without slowing down the sampling, since the computational complexity of evaluating the expert denoiser 150, D, at each noise level remains the same. That is, the generation process in text-to-image diffusion models qualitatively changes throughout synthesis: initially, the model focuses on generating globally coherent content aligned with a text prompt, while later in the synthesis process, the model largely ignores the text conditioning and attempts to produce visually high-quality outputs. The use of multiple expert denoisers 150 allows the expert denoisers 150 to be specialized for different behaviors during different intervals of the iterative synthesis process.

In some embodiments, the ensemble of expert denoisers 150 can be trained by first training a denoiser to denoise images having an arbitrary (i.e., any) amount of noise, and then further training the denoiser on particular noise ranges to obtain the expert denoisers. In such cases, the model trainer 116 can train the first denoiser to denoise images having an arbitrary amount of noise. Then, the model trainer 116 can retrain the first denoiser to denoise images that include an amount of noise in (1) a noise range that is an upper half of the previous noise range for which the first denoiser was trained to denoise images, and (2) a noise range that is a lower half of the previous noise range for which the first denoiser was trained to denoise images, thereby obtaining two expert denoisers for the upper half noise range and the lower half noise range. The same process can be repeated to retrain the two expert denoisers to obtain two additional expert denoisers for the upper half and the lower half of the noise range of each of the two expert denoisers, etc. Advantageously, such a training process is more computationally efficient than individually training a number of expert denoisers on corresponding noise ranges.

More formally, each of the expert denoisers 150 is trained to recover clean images given their corrupted versions, generated by adding Gaussian noise of varying scales. The training objective can be written as:

[symbol]

p_{dxa}(x_{ckan},e),p(ε),p(σ)[λ(σ)∥D(x_{clean}+σε; e, σ)−x_{clean}∥₂²], (3)

where p_{data} (x_{clean}, e) represents the training data distribution that produces training image-text pairs, p(ε)= [symbol] (0, I) is the standard Normal distribution, p(σ) is the distribution in which noise levels are sampled from, and λ(σ) is the loss weighting factor. However, naively training the expert denoisers 150 as separate denoising models for different stages can significantly increase the training cost, as each expert denoiser 150 needs to be trained from scratch. As described, in some embodiments, the model trainer 116 instead uses a branching strategy based on a binary tree implementation to train the expert denoisers 150 relatively efficiently. In such cases, the model trainer 116 first trains a model shared among all noise levels using the full noise level distribution, denoted as p(σ). Then, the model trainer 116 initializes two expert denoisers from the baseline model. Such expert denoisers are referred to herein as level 1 expert denoisers, as these expert denoisers are trained on the first level of the binary tree. The two level 1 expert denoisers are trained on the noise distributions p₀¹(σ) and p₁¹(σ), which are obtained by splitting p(σ) equally by area. Accordingly, the level 1 expert denoiser trained on p₀¹(σ) specializes in low noise levels, while the level 1 expert trained on p₁¹(σ) specializes in high noise levels. In some embodiments, p(σ) follows a log-normal distribution. After the level 1 expert models are trained, the model trainer 116 splits each of their corresponding noise intervals in a similar fashion as described above and trains expert denoisers for each sub-interval. This process is repeated recursively for multiple levels. In general, at level l, the noise distribution p(σ) is spit into 2^{l} intervals of equal area given by {pᵢ^{l}(σ)}ᵢ₌ₙ²^{^{l}}⁻¹, with expert denoiser i being trained on the distribution pᵢ^{l}(σ). Let such an expert denoiser or node in the binary tree be denoted by Eᵢ^{l}. Ideally, at each level l, the model trainer 116 trains 2^{l} models. However, such training can be impractical, as the model size grows exponentially with the depth of the binary tree. Also, experience has shown that expert denoisers trained at many of the intermediate intervals do not contribute much toward the performance of the final model. Accordingly, in some embodiments, the model trainer 116 focuses mainly on growing the tree from the left-most and the right-most nodes at each level of the binary tree: E₀^{l} and E₂_{^{l}}₋₁^{l}. The right-most interval contains samples at high noise levels. Good denoising at high noise levels is critical for improving text conditioning as core image formation occurs in such a regime. Hence, having a dedicated model in such a regime can be desirable. Similarly, the model trainer 116 focuses on training the models at lower noise levels as the final steps of denoising happen in such a regime during sampling. Accordingly, good expert denoisers are needed to obtain sharp results. Finally, the model trainer 116 trains a single expert denoiser on all the intermediate noise intervals that are between the two extreme intervals. In such cases, the final denoising model can include three expert denoisers: an expert denoiser focusing on the low noise levels (given by the leftmost interval in the binary tree), an expert denoiser focusing on high noise levels (given by the rightmost interval in the binary tree), and a single expert denoiser for learning all intermediate noise intervals. Other types of ensembles of expert denoisers can be used in some embodiments.

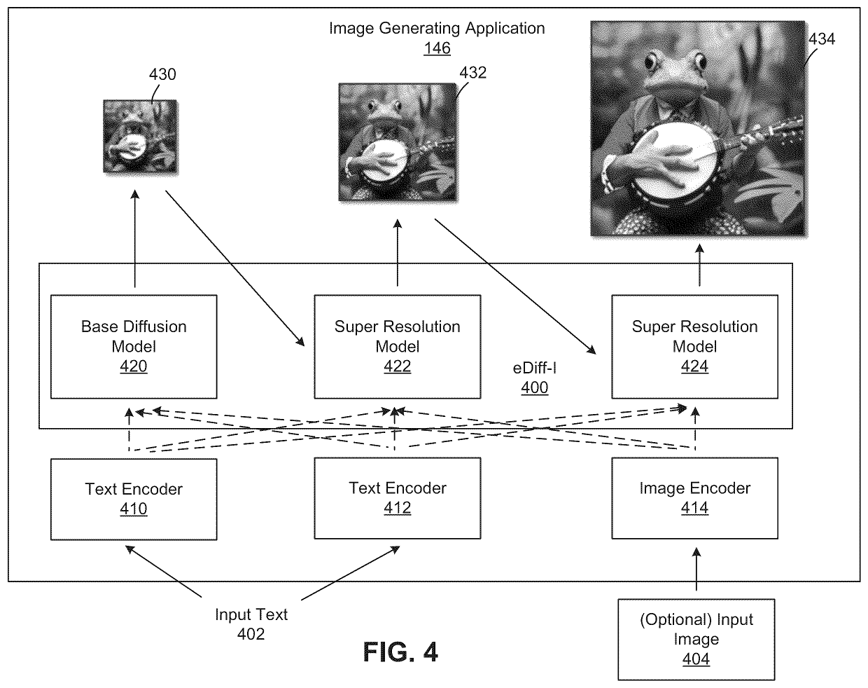

FIG. 4 is a more detailed illustration of how the image generating application 146 of FIG. 1 generates an image. As shown, in some embodiments, the image generating application 146 performs denoising diffusion using an eDiff-I model 400 that includes a base diffusion model 420, a super-resolution model 422, and a super-resolution model 424. Each of the base diffusion model 420, the super-resolution model 422, and the super-resolution model 424 includes an ensemble of expert denoisers, similar to the ensemble of expert denoisers 150, described above in conjunction with FIG. 3.

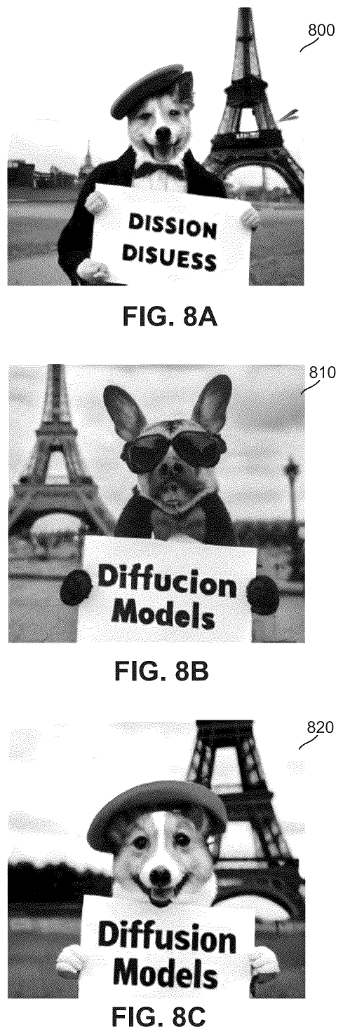

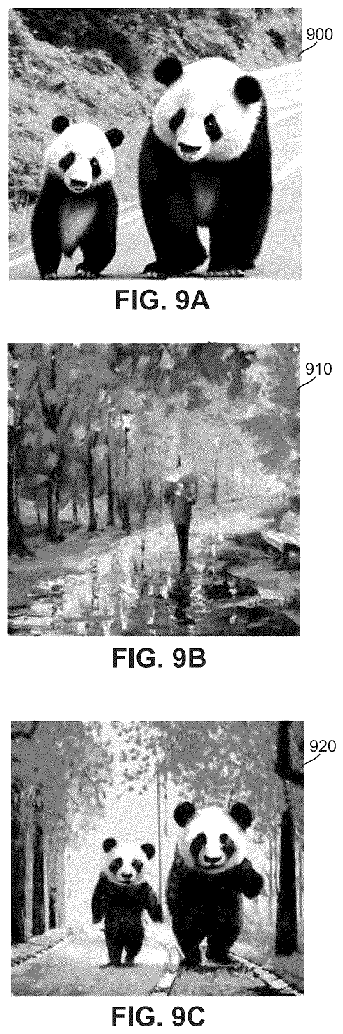

In operation, the image generating application 146 receives an input text 402 and (optionally) an input image 404. The image generating application 146 encodes the input text 402 using text encoders 410 and 412 to generate text embeddings, and the image generating application 146 encodes the input image 404 using an image encoder 414 to generate an image embedding. In some embodiments, multiple different encoders (e.g., text encoders 410 and 412 and image encoder 414) are used to encode the input text and/or image into multiple text and/or image embeddings, respectively. Such text and image embeddings can help the eDiff-I model 400 to generate images that align with the input text and (optional) input image better than images generated using a single encoder. For example, in some embodiments, the image generating application 146 can encode the input text 402 into different text embeddings using (1) a trained alignment model, such as the CLIP text encoder, that is used to align images with corresponding text, and (2) a trained language model, such as the T5 text encoder, that understands the English language better than the alignment model. In such cases, images generated using the text embeddings can align with the input text 402 as well as include correct spellings of words in the input text 402, as discussed in greater detail below in conjunction with FIGS. 8A-8C. In addition, an image embedding can be used to condition the denoising diffusion so as to generate an image that is stylistically similar to the input image 404, as discussed in greater detail below in conjunction with FIGS. 9A-9C.

Using the text embeddings generated by the text encoders 410 and 412, the image embedding generated by the image encoder 414, and the base diffusion model 420, the image generating application 146 performs denoising diffusion to denoise an image that includes random noise (not shown) to generate an image 430 at a particular resolution. In some embodiments, the text embeddings and image embedding can be concatenated together, and the denoising diffusion can be conditioned on the concatenated embeddings. Then, the image generating application 146 performs denoising diffusion using the text embeddings, the image embedding, and the super-resolution model 422 to denoise the image 430 and generate an image 432 having a higher resolution than the image 430. Similarly, the image generating application 146 performs denoising diffusion using the text embeddings, the image bedding, and the super-resolution model 424 to denoise the image 432 and generate an image 434 having a higher resolution than the image 432. Although two super-resolution models 422 and 424 are shown for illustrative purposes, in some embodiments, any number of super-resolution models can be used in conjunction with a base diffusion model to generate an image.

In some embodiments, the base diffusion model 420 can generate images having 64×64 resolution, and the super-resolution model 422 and the super-resolution model 424 can progressively upsample images to 256×256 and 1024×1024 resolutions, respectively. Each of the base diffusion model 420, the super-resolution model 422, and the super-resolution model 424 can be conditioned on text and optionally an image. For example, in some embodiments, the base diffusion model 420, the super-resolution model 422, and the super-resolution model 424 are each conditioned on text through T5 and CLIP text embeddings and optionally a CLIP image embedding.

The training of text-conditioned super-resolution models, such as the super-resolution models 422 and 424 is similar to the training of the expert denoisers 150, described above in conjunction with FIG. 3, except each of the super-resolution models 422 and 424 also takes a low-resolution image as conditioning input. In some embodiments, corruptions can be applied to the low-resolution input image during training to enhance the generalization ability of each of the super-resolution models 422 and 424. In particular, adding corruption in the form of random degradation during training allows the models to be better generalized to remove artifacts that can exist in outputs generated by the base diffusion model 420. In some embodiments, to train the following conditional embeddings can be used during training: (1) T5-XXL text embeddings, (2) CLIP L/14 text embeddings, and (3) CLIP L/14 image embeddings. In such cases, the embeddings can be pre-computed, since computing the embeddings online can be computationally expensive. The projected conditional embeddings can be added to the time embedding, and cross attention can be performed at multiple resolutions. In addition, random dropout can be used on each embedding independently during training. When an embedding is dropped, the model trainer 116 zeroes out the whole embedding tensor. When all three embeddings are dropped, the training corresponds to unconditional training, which can be useful for performing classifier-free guidance.

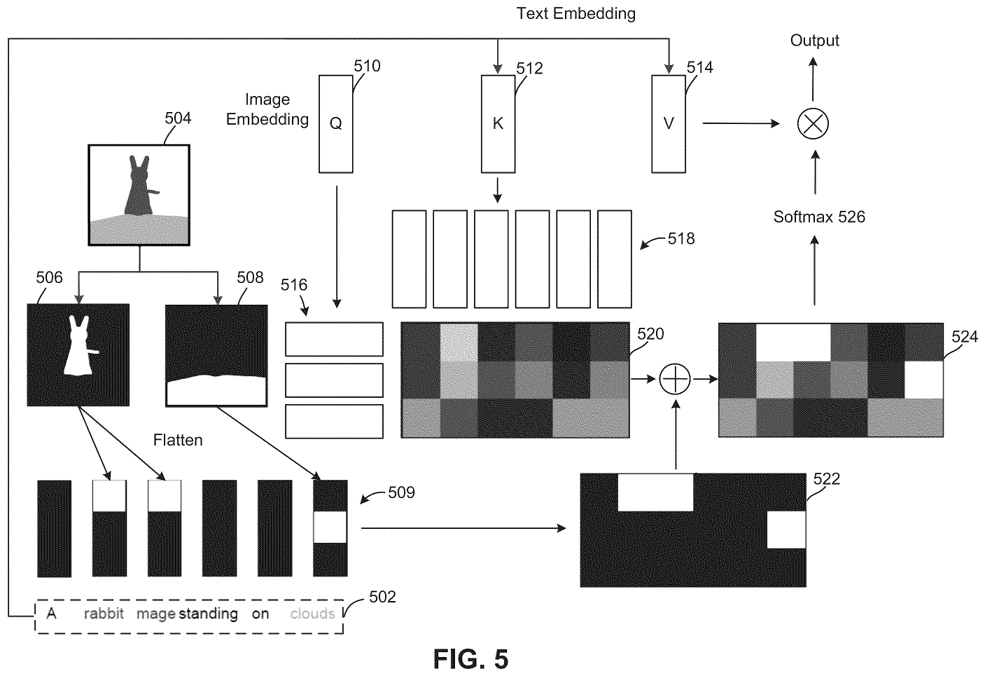

FIG. 5 illustrates how a mask can be used to specify the locations of objects in an image generated using an ensemble of expert denoisers, according to various embodiments. Enabling the user to specify the spatial locations of objects in an image being generated is also referred to herein as “paint-with-words.” As shown, the image generating application 146 can receive as input text 502 and a mask 504 specifying where objects should be located in a generated image. In some embodiments, the correspondence between words in the text 502 and pixels associated with objects in the mask 504 is also specified. For example, the image generation application 146 could display a user interface that permits a user to select a phrase from the text 502 and then doodle on a canvas to create a binary mask corresponding to the selected phrase. Illustratively, a correspondence between the words “rabbit mage” in the text 502 and a region of the image 504 is used to generate a mask 506, and a correspondence between the word “clouds” in the text 502 and another region of the image 504 is used to generate a mask 508. The image generating application 146 flattens the masks 506 and 508 to generate vectors 509, which indicate how regions of an attention map 520 should be up-weighted. The attention map 520 cross attends between the text and image, and the attention map 520 is a matrix computed from queries 510 that are flattened image features and keys 512 and values 514 that are flattened text features. The vectors 509 are combined into a matrix 522 that is added to the attention map 520 to generate an updated attention map 524. The image generating application 146 then computes a softmax 526 of the updated attention map 524 and combines the result with a text embedding 514 to generate an embedding that is input into a next layer of an expert denoiser, such as one of the expert denoisers 150.

More formally, masks can be input into all cross-attention layers and bilinearly downsampled to match the resolution of each layer. In some embodiments, the masks are used to create an input attention matrix A∈ [symbol] , where Nᵢ and Nₜ are the number of image and text tokens, respectively. Each column in the matrix A can be generated by flattening the mask corresponding to the phrase that includes the text token of that column. The image generating application 146 sets the column to zero if the corresponding text token is not in any phrases selected by the user. Then, the image generating application 146 adds the input attention matrix to the original attention matrix in the cross-attention layer, which now computes the output as softmax

$$( \frac{{QK}^{T} + wA}{\sqrt{{d}_{k}}} ) V ,$$

where Q is the query embeddings from image tokens, K and V are key and value embeddings from text tokens, dₖ is the dimensionality of Q and K, and w is a scalar weight that controls the strength of user input attention. Intuitively, when a user paints a phrase on a region, image tokens in such a region are encouraged to attend more to the text tokens included in the phrase. As a result, the semantic concept corresponding to the phrase is more likely to appear in the specified area. Experience has shown that it can be beneficial to use a larger weight at higher noise levels and to make the influence of the matrix A irrelevant to the scale of Q and K, which corresponds to a schedule that works well empirically:

w=w′·log(1+σ)·max(QK^{T}), (4)

where w′ is a scalar that can be specified by a user.

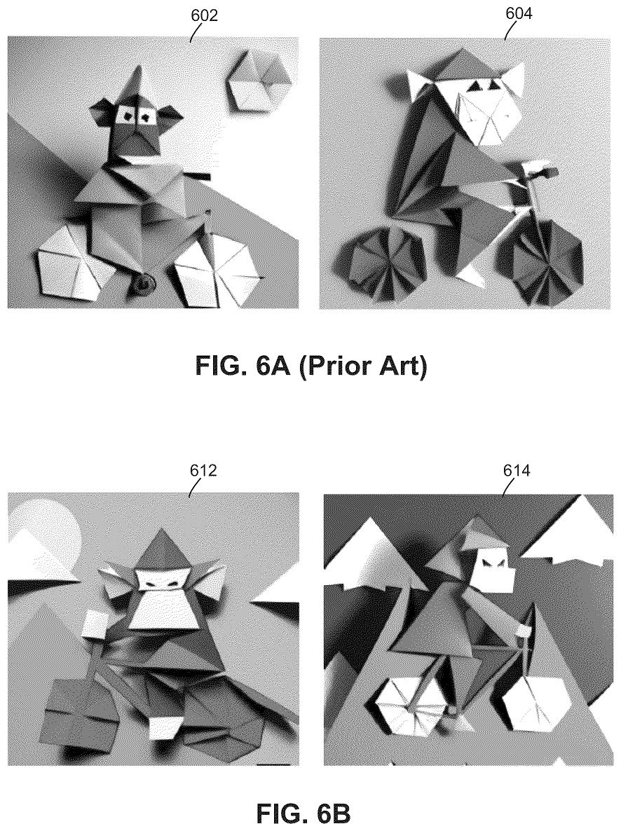

FIG. 6A illustrates exemplar images generated using conventional denoising diffusion models, according to the prior art. As shown, images 602 and 604 were generated using conventional denoising diffusion techniques for the text input: “An origami of a monkey dressed as a monk riding a bike on a mountain.” Illustratively, the image 604 does not include a mountain, as specified in the text input.

FIG. 6B illustrates exemplar images generated using ensembles of expert denoisers, according to various embodiments. As shown, images 612 and 614 were generated using the eDiff-I model 400, described above in conjunction with FIG. 4, for the text input: “An origami of a monkey dressed as a monk riding a bike on a mountain.” Illustratively, both of the images 612 and 614 include a mountain, as specified in the text input.

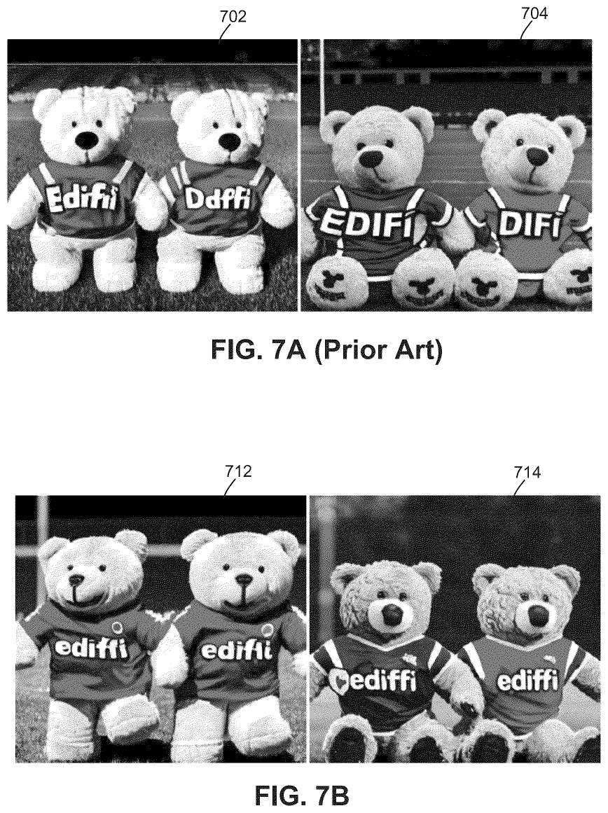

FIG. 7A illustrates additional exemplar images generated using conventional denoising diffusion models, according to the prior art. As shown, images 702 and 704 were generated using conventional denoising diffusion techniques for the text input: “A 4k dslr photo of two teddy bears wearing a sports jersey with the text “eDiffi” written on it. They are on a soccer field.” Illustratively, the “eDiffi” is misspelled in the images 702 and 704.

FIG. 7B illustrates additional exemplar images generated using ensembles of expert denoisers, according to various embodiments. As shown, images 712 and 714 were generated using the eDiff-I model 400, described above in conjunction with FIG. 4, for the text input: “A 4k dslr photo of two teddy bears wearing a sports jersey with the text “eDiffi” written on it. They are on a soccer field.” Illustratively, both of the images 712 and 714 include the correct spelling of “eDiffi,” as specified in the text input.

FIG. 8A illustrates an exemplar image generated using denoising diffusion conditioned on one text embedding, according to various embodiments. As shown, an image 800 was generated using the eDiff-I model 400 conditioned on a text embedding for the text input: “A photo of a cute corgi wearing a beret holding a sign that says ‘Diffusion Models’.” There is Eiffel tower in the background.” In particular, the image 800 was generated using the eDiff-I model 400 that took as input a text embedding generated by the CLIP text encoder, which is an alignment model that is used to align images with corresponding text. Illustratively, while the image 800 depicts a corgi wearing a beret with the Eiffel tower in the background, the corgi is holding a sign with “Diffusion Models” misspelled.

FIG. 8B illustrates an exemplar image generated using denoising diffusion conditioned on another text embedding, according to various embodiments. As shown, an image 800 was generated using denoising diffusion and the eDiff-I model 400 conditioned on a text embedding for the text input: “A photo of a cute corgi wearing a beret holding a sign that says ‘Diffusion Models.’” In particular, the image 810 was generated using the eDiff-I model 400 that took as input a text embedding generated by the T5 text encoder, which is a language model that understands the English language better than the alignment model used to generate the text embedding for the image 800. Illustratively, “Diffusion Models” is spelled more correctly in the image 810 than in the image 800. However, the dog depicted in the image 810 is not a corgi, and the dog is wearing sunglasses rather than a beret.

FIG. 8C illustrates an exemplar image generated using denoising diffusion conditioned on two text embeddings, according to various embodiments. As shown, an image 800 was generated using denoising diffusion and the eDiff-I model 400 conditioned on two text embeddings for the text input: “A photo of a cute corgi wearing a beret holding a sign that says Diffusion Models.” In particular, the image 820 was generated using the eDiff-I model 400 that took as input text embeddings generated by the CLIP text encoder, described above in conjunction with FIG. 8B, and the T5 text encoder, described above in conjunction with FIG. 8C. Illustratively, the image 830 depicts a corgi wearing a beret with the Eiffel tower in the background, and the corgi is holding a sign with “Diffusion Models” spelled correctly.

FIG. 9A illustrates an exemplar image generated using denoising diffusion conditioned on two text embeddings, according to various embodiments. As shown, an image 900 was generated using denoising diffusion and the eDiff-I model 400, described above in conjunction with FIG. 4, conditioned on two text embeddings for the text input: “A photo of two pandas walking on a road.”

FIG. 9B illustrates an exemplar reference image, according to various embodiments. As shown, a reference image 910 can be used to transfer a style of the reference image to an image generated using the eDiff-I model 400.

FIG. 9C illustrates an exemplar image generated using denoising diffusion conditioned on two text embeddings and a reference image embedding, according to various embodiments. As shown, an image 920 was generated using the eDiff-I model 400, conditioned on two text embeddings for the text input: “A photo of two pandas walking on a road” and an image embedding for the reference image 910. Illustratively, the image 920 depicts two pandas walking on a road, and the image 920 is similar stylistically to the reference image 910. Experience has shown that when conditioned on text and image embeddings, such as T5 and CLIP text embeddings and a CLIP image embedding, the use of the image embeddings enables style transfer during image generation using the eDiff-I model 400.

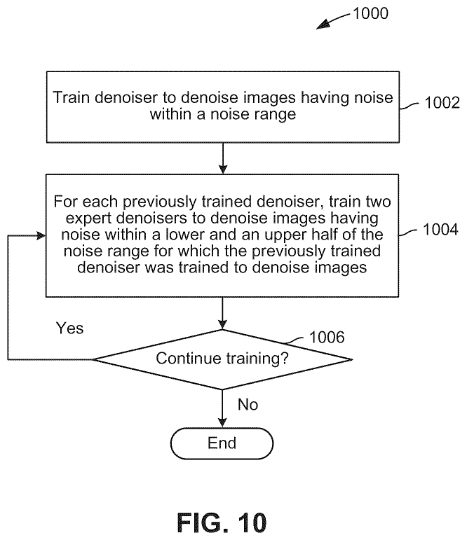

FIG. 10 is a flow diagram of method steps for training an ensemble of expert denoisers, according to various embodiments. Although the method steps are described in conjunction with the system of FIGS. 1-5, persons skilled in the art will understand that any system configured to perform the method steps in any order falls within the scope of the present embodiments.

As shown, a method 1000 begins at step 1002, where the model trainer 116 trains a denoiser to denoise images having noise within a noise range. In some embodiments, the noise range is a full noise level distribution that includes all amounts of noise. In some embodiments, the denoiser does not need to be fully trained at step 1002, because training continues at step 1004.

At step 1004, for each denoiser trained at a previous step, the model trainer 116 trains a two expert denoisers to denoise images having noise within a lower and an upper half of the noise range for which the previously trained denoiser was trained to denoise. After step 1002, one denoiser has been trained. Immediately after step 1002, at step 1004, two expert denoisers are trained to denoise images having noise within a lower and an upper half of the noise range for which the denoiser was trained to denoise images.

At step 1006, if the training is to continue, then the method 1000 returns to step 1004, where for each expert denoiser trained at the previous step, the model trainer 116 trains two expert denoisers to denoise images having noise within a lower and an upper half of the noise range for which the expert denoiser was trained to denoise images. On the other hand, if the training is not to continue, then the method 1000 ends. In some embodiments, the model trainer 116 focuses mainly on growing the tree from the left-most and the right-most nodes at each level of the binary tree. As described, good denoising at high noise levels is critical for improving text conditioning as core image formation occurs in such a regime, and having a dedicated model in such a regime can be desirable. Similarly, the model trainer 116 focuses on training the models at lower noise levels as the final steps of denoising happen in such a regime during sampling, so good expert denoisers are needed to obtain sharp results. In addition, the model trainer 116 trains a single expert denoiser on all the intermediate noise intervals that are between the two extreme intervals.

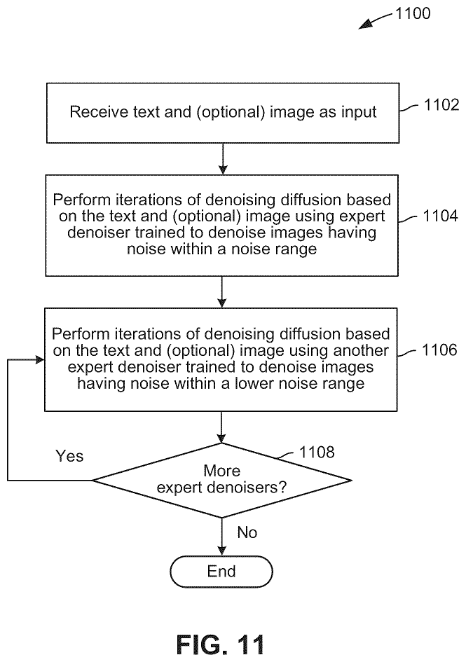

FIG. 11 is a flow diagram of method steps for generating an image using an ensemble of expert denoisers, according to various embodiments. Although the method steps are described in conjunction with the system of FIGS. 1-5, persons skilled in the art will understand that any system configured to perform the method steps in any order falls within the scope of the present embodiments.

As shown, a method 1100 begins at step 1102, where the image generating application 146 receives text and an (optional) image as input. As described, text and images are used herein as reference examples of inputs. However, in some embodiments, the image generating application 146 can take any suitable application-specific conditioning inputs, such as a text prompt, an image, an embedding, audio, and/or the like.

At step 1104, the image generating application 146 performs a number of iterations of denoising diffusion based on the input text and (optional) image using an expert denoiser that is each trained to denoise images having an amount of noise within a particular noise range. In some embodiments, the image generating application 146 generates one or more text embeddings, such as multiple text embeddings using different text encoders, and an (optional) image embedding using an image encoder, and the uses the expert denoiser to perform denoising diffusion conditioned on the text and (optional) image embeddings. As described, the denoising diffusion can include iteratively using the expert denoiser to remove noise from a noisy image (beginning with an image that include random noise) to generate a clean image, adding to the clean image a smaller amount of noise than was present in the noisy image to generate another noisy image, and repeats these steps, until a noisy image is generated that includes an amount of noise that is less than the noise range for which the expert denoiser was trained to denoise.

At step 1106, the image generating application 146 performs a number of iterations of denoising diffusion based on the text and (optional) image using another expert denoiser trained to denoise images having noise within a lower noise range than previously used expert denoisers were trained to denoise. Step 1106 is similar to step 1104, except the expert denoiser that is trained to denoise images having noise within a lower noise range is used.

At step 1108, if there are more expert denoisers, then the method 1100 returns to step 1106, where the image generating application 146 again performs a number of iterations of denoising diffusion based on the text and (optional) image using another expert denoiser trained to denoise images having noise within a lower noise range than previously used expert denoisers were trained to denoise.

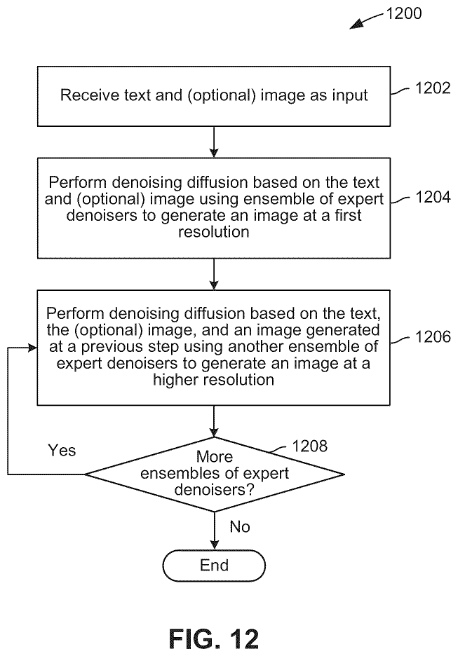

FIG. 12 is a flow diagram of method steps for generating an image using multiple ensembles of denoisers, according to various embodiments. Although the method steps are described in conjunction with the system of FIGS. 1-5, persons skilled in the art will understand that any system configured to perform the method steps in any order falls within the scope of the present embodiments.

As shown, a method 1200 begins at step 1202, where the image generating application 146 receives text and an (optional) image as input. As described, although text and images are used herein as reference examples of inputs, in some embodiments, the image generating application 146 can take any suitable application-specific conditioning inputs, such as a text prompt, an image, an embedding, audio, and/or the like.

At step 1204, the image generating application 146 performs denoising diffusion based on the text and (optional) image using an ensemble of expert denoisers to generate an image at a first resolution. In some embodiments, the denoising diffusion using the ensemble of expert denoisers can be performed according to the method 1100, described above in conjunction with FIG. 11.

At step 1206, the image generating application 146 performs denoising diffusion based on the text, the (optional) image, and an image generated at a previous step using another ensemble of expert denoisers to generate an image at a higher resolution. Step 1206 is similar to step 1204, except the denoising diffusion is further conditioned on the image generated at the previous step, which is initially step 1204.

At step 1208, if there are more ensembles of expert denoisers, then the method 1200 returns to step 1206, where the image generating application 146 again performs denoising diffusion based on the text, the (optional) image, and an image generated at a previous step using another ensemble of expert denoisers to generate an image at a higher resolution.

In sum, techniques are disclosed for generating content items, such as images, using one or more ensembles of expert denoiser models. In some embodiments, each expert denoiser in an ensemble of expert denoisers is trained to denoise images having an amount of noise within a different noise range. Given an input text and (optionally) an input image, the expert denoisers in an ensemble of expert denoisers are sequentially applied to denoise images having an amount of noise within the different noise ranges for which the expert denoisers were trained, beginning from an image that includes random noise and progressing to a clean image that does not include noise, or that includes less than a threshold amount of noise. The input text and input image can also be encoded into text and image embeddings using multiple different text and image encoders, respectively. In addition, multiple ensembles of expert denoisers can be used to generate an image at a first resolution and then increase the image resolution. In some embodiments, each ensemble of expert denoisers can be trained by first training a denoiser to denoise images having any amount of noise, and then re-training the trained denoiser on particular noise ranges to obtain the expert denoisers.

Although discussed herein primarily with respect to images as a reference example, in some embodiments, techniques disclosed herein can be applied to generate content items that include any technically feasible data that can be corrupted to various degrees, such as bitmap images, video clips, audio clips, three-dimensional (3D) models, time series data, latent representations, etc. In such cases, techniques disclosed herein can be applied to reduce and/or eliminate corruption in the content items to generate clean content items that do not include corruption or include less than a threshold level of corruption.

Although discussed herein primarily with respect to noise as a reference example, in some embodiments, content items can include any technically feasible corruption, such as noise, blur, filtering, masking, pixelation, dimensionality reduction, compression, quantization, spatial decimation, and/or temporal decimation. In such cases, techniques disclosed herein can be applied to reduce and/or eliminate the corruption in the content items to generate clean content items that do not include corruption or include less than a threshold level of corruption.

At least one technical advantage of the disclosed techniques relative to the prior art is that, with the disclosed techniques, content items that more accurately represent textual input can be generated relative to what typically can be generated using conventional denoising diffusion models. Further, with the disclosed techniques, an ensemble of expert denoisers can be trained in a computationally efficient manner relative to training each expert denoiser separately. In addition, the disclosed techniques permit users to control where objects described in textual input appear in a generated content item. These technical advantages represent one or more technological improvements over prior art approaches.
1. In some embodiments, a computer-implemented method for generating a content item comprises performing one or more first denoising operations based on an input and a first machine learning model to generate a first content item, and performing one or more second denoising operations based on the input, the first content item, and a second machine learning model to generate a second content item, wherein the first machine learning model is trained to denoise content items having an amount of corruption within a first corruption range, the second machine learning model is trained to denoise content items having an amount of corruption within a second corruption range, and the second corruption range is lower than the first corruption range.
2. The computer-implemented method of clause 1, wherein the input includes an input text, and the method further comprises encoding the input text using a plurality of text encoders to generate a plurality of text embeddings, wherein the one or more first denoising operations and the one or more second denoising operations are based on the plurality of text embeddings.
3. The computer-implemented method of clauses 1 or 2, wherein the input includes an input content item, and the method further comprises encoding the input content item using a content item encoder to generate a content item embedding, wherein the one or more first denoising operations and the one or more second denoising operations are based on the content item embedding.
4. The computer-implemented method of any of clauses 1-3, wherein the input includes an input text and an input mask, and the method further comprises modifying an attention map based on the input mask, wherein the one or more first denoising operations and the one or more second denoising operations are based on the attention map.
5. The computer-implemented method of any of clauses 1-4, wherein each of the one or more first denoising operations and the one or more second denoising operations includes one or more denoising diffusion operations.
6. The computer-implemented method of any of clauses 1-5, further comprising performing one or more third denoising operations based on the input and the second content item using a third machine learning model to generate a third content item, wherein the third machine learning model is trained to denoise content items having an amount of corruption within a third corruption range that is lower than the second corruption range.
7. The computer-implemented method of any of clauses 1-6, further comprising performing one or more denoising operations based on the input and the second content item using one or more additional machine learning models to generate a third content item, wherein the third content item has a higher resolution than the second content item.
8. The computer-implemented method of any of clauses 1-7, wherein the second content item includes less corruption than the first content item.
9. The computer-implemented method of any of clauses 1-8, wherein the one or more first denoising operations are performed until the first content item is generated that includes an amount of corruption that is less than the first corruption range.
10. The computer-implemented method of any of clauses 1-9, further comprising training a third machine learning model to denoise content items having an amount of corruption within a third corruption range that includes the first corruption range and the second corruption range, retraining the third machine learning model to denoise content items having an amount of corruption within the first corruption range to generate the first machine learning model, and retraining the third machine learning model to denoise content items having an amount of corruption within the second corruption range to generate the second machine learning model.
11. In some embodiments, one or more non-transitory computer-readable media storing instructions that, when executed by at least one processor, cause the at least one processor to perform steps for generating a content item, the steps comprising performing one or more first denoising operations based on an input and a first machine learning model to generate a first content item, and performing one or more second denoising operations based on the input, the first content item, and a second machine learning model to generate a second content item, wherein the first machine learning model is trained to denoise content items having an amount of corruption within a first corruption range, the second machine learning model is trained to denoise content items having an amount of corruption within a second corruption range, and the second corruption range is lower than the first corruption range.
12. The one or more non-transitory computer-readable media of clause 11, wherein the input includes an input text, and the instructions, when executed by the at least one processor, further cause the at least one processor to perform the step of encoding the input text using a plurality of text encoders to generate a plurality of text embeddings, wherein the one or more first denoising operations and the one or more second denoising operations are based on the plurality of text embeddings.
13. The one or more non-transitory computer-readable media of clauses 11 or 12, wherein the input includes an input content item, and the instructions, when executed by the at least one processor, further cause the at least one processor to perform the step of encoding the input content item using a content item encoder to generate a content item embedding, wherein the one or more first denoising operations and the one or more second denoising operations are based on the content item embedding.
14. The one or more non-transitory computer-readable media of any of clauses 11-13, wherein the input includes an input mask, and the instructions, when executed by the at least one processor, further cause the at least one processor to perform the step of modifying an attention map based on the input mask, wherein the one or more first denoising operations and the one or more second denoising operations are based on the attention map.
15. The one or more non-transitory computer-readable media of any of clauses 11-14, wherein the instructions, when executed by the at least one processor, further cause the at least one processor to perform the step of receiving, via a user interface, the input mask and a specification of at least one portion of the input text that corresponds to at least one portion of the input mask.
16. The one or more non-transitory computer-readable media of any of clauses 11-15, wherein the instructions, when executed by the at least one processor, further cause the at least one processor to perform the step of performing one or more third denoising operations based on the input and the second content item using a third machine learning model to generate a third content item, wherein the third machine learning model is trained to denoise content items having an amount of corruption within a third corruption range that is lower than the second corruption range.
17. The one or more non-transitory computer-readable media of any of clauses 11-16, wherein the second content item includes less than a threshold amount of corruption.
18. The one or more non-transitory computer-readable media of any of clauses 11-17, wherein the one or more first denoising operations are performed until the first content item is generated that includes an amount of corruption that is less than the first corruption range.
19. The one or more non-transitory computer-readable media of any of clauses 11-18, wherein the instructions, when executed by the at least one processor, further cause the at least one processor to perform the steps of training a third machine learning model to denoise content items having an amount of corruption within a third corruption range that includes the first corruption range and the second corruption range, retraining the third machine learning model to denoise content items having an amount of corruption within the first corruption range to generate the first machine learning model, and retraining the third machine learning model to denoise content items having an amount of corruption within the second corruption range to generate the second machine learning model.
20. In some embodiments, a system comprises one or more memories storing instructions, and one or more processors that are coupled to the one or more memories and, when executing the instructions, are configured to perform one or more first denoising operations based on an input and a first machine learning model to generate a first content item, and perform one or more second denoising operations based on the input, the first content item, and a second machine learning model to generate a second content item, wherein the first machine learning model is trained to denoise content items having an amount of corruption within a first corruption range, the second machine learning model is trained to denoise content items having an amount of corruption within a second corruption range, and the second corruption range is lower than the first corruption range.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a content item, the method comprising:
performing one or more first denoising operations based on an input and a first machine learning model to generate a first content item; and
performing one or more second denoising operations based on the input, the first content item, and a second machine learning model to generate a second content item,
wherein the first machine learning model is trained to denoise content items having an amount of corruption within a first corruption range, the second machine learning model is trained to denoise content items having an amount of corruption within a second corruption range, and the second corruption range is lower than the first corruption range.

2. The computer-implemented method of claim 1, wherein the input includes an input text, and the method further comprises encoding the input text using a plurality of text encoders to generate a plurality of text embeddings, wherein the one or more first denoising operations and the one or more second denoising operations are based on the plurality of text embeddings.

3. The computer-implemented method of claim 1, wherein the input includes an input content item, and the method further comprises encoding the input content item using a content item encoder to generate a content item embedding, wherein the one or more first denoising operations and the one or more second denoising operations are based on the content item embedding.

4. The computer-implemented method of claim 1, wherein the input includes an input text and an input mask, and the method further comprises modifying an attention map based on the input mask, wherein the one or more first denoising operations and the one or more second denoising operations are based on the attention map.

5. The computer-implemented method of claim 1, wherein each of the one or more first denoising operations and the one or more second denoising operations includes one or more denoising diffusion operations.

6. The computer-implemented method of claim 1, further comprising performing one or more third denoising operations based on the input and the second content item using a third machine learning model to generate a third content item, wherein the third machine learning model is trained to denoise content items having an amount of corruption within a third corruption range that is lower than the second corruption range.

7. The computer-implemented method of claim 1, further comprising performing one or more denoising operations based on the input and the second content item using one or more additional machine learning models to generate a third content item, wherein the third content item has a higher resolution than the second content item.

8. The computer-implemented method of claim 1, wherein the second content item includes less corruption than the first content item.

9. The computer-implemented method of claim 1, wherein the one or more first denoising operations are performed until the first content item is generated that includes an amount of corruption that is less than the first corruption range.

10. The computer-implemented method of claim 1, further comprising:
training a third machine learning model to denoise content items having an amount of corruption within a third corruption range that includes the first corruption range and the second corruption range;
retraining the third machine learning model to denoise content items having an amount of corruption within the first corruption range to generate the first machine learning model; and
retraining the third machine learning model to denoise content items having an amount of corruption within the second corruption range to generate the second machine learning model.

11. One or more non-transitory computer-readable media storing instructions that, when executed by at least one processor, cause the at least one processor to perform steps for generating a content item, the steps comprising:
performing one or more first denoising operations based on an input and a first machine learning model to generate a first content item; and
performing one or more second denoising operations based on the input, the first content item, and a second machine learning model to generate a second content item,
wherein the first machine learning model is trained to denoise content items having an amount of corruption within a first corruption range, the second machine learning model is trained to denoise content items having an amount of corruption within a second corruption range, and the second corruption range is lower than the first corruption range.

12. The one or more non-transitory computer-readable media of claim 11, wherein the input includes an input text, and the instructions, when executed by the at least one processor, further cause the at least one processor to perform the step of encoding the input text using a plurality of text encoders to generate a plurality of text embeddings, wherein the one or more first denoising operations and the one or more second denoising operations are based on the plurality of text embeddings.

13. The one or more non-transitory computer-readable media of claim 12, wherein the input includes an input content item, and the instructions, when executed by the at least one processor, further cause the at least one processor to perform the step of encoding the input content item using a content item encoder to generate a content item embedding, wherein the one or more first denoising operations and the one or more second denoising operations are based on the content item embedding.

14. The one or more non-transitory computer-readable media of claim 11, wherein the input includes an input mask, and the instructions, when executed by the at least one processor, further cause the at least one processor to perform the step of modifying an attention map based on the input mask, wherein the one or more first denoising operations and the one or more second denoising operations are based on the attention map.

15. The one or more non-transitory computer-readable media of claim 14, wherein the instructions, when executed by the at least one processor, further cause the at least one processor to perform the step of receiving, via a user interface, the input mask and a specification of at least one portion of the input text that corresponds to at least one portion of the input mask.

16. The one or more non-transitory computer-readable media of claim 11, wherein the instructions, when executed by the at least one processor, further cause the at least one processor to perform the step of performing one or more third denoising operations based on the input and the second content item using a third machine learning model to generate a third content item, wherein the third machine learning model is trained to denoise content items having an amount of corruption within a third corruption range that is lower than the second corruption range.

17. The one or more non-transitory computer-readable media of claim 11, wherein the second content item includes less than a threshold amount of corruption.

18. The one or more non-transitory computer-readable media of claim 11, wherein the one or more first denoising operations are performed until the first content item is generated that includes an amount of corruption that is less than the first corruption range.

19. The one or more non-transitory computer-readable media of claim 11, wherein the instructions, when executed by the at least one processor, further cause the at least one processor to perform the steps of:
training a third machine learning model to denoise content items having an amount of corruption within a third corruption range that includes the first corruption range and the second corruption range;
retraining the third machine learning model to denoise content items having an amount of corruption within the first corruption range to generate the first machine learning model; and
retraining the third machine learning model to denoise content items having an amount of corruption within the second corruption range to generate the second machine learning model.

20. A system, comprising:
one or more memories storing instructions; and
one or more processors that are coupled to the one or more memories and, when executing the instructions, are configured to:
perform one or more first denoising operations based on an input and a first machine learning model to generate a first content item, and
perform one or more second denoising operations based on the input, the first content item, and a second machine learning model to generate a second content item,
wherein the first machine learning model is trained to denoise content items having an amount of corruption within a first corruption range, the second machine learning model is trained to denoise content items having an amount of corruption within a second corruption range, and the second corruption range is lower than the first corruption range.
